(19) United States
(12) Patent Application Publication
(10) Pub. No.: US 2026/0101836 A1
(43) Pub. Date: Apr. 16, 2026

(54) Method and System for Determining a Machine- and Spreading Material-Specific and Lane-Independent Maximum Working Width

(71) Applicant: Amazonen-Werke H. Dreyer SE & Co. KG, Hasbergen-Gaste (DE)

(72) Inventor: Thomas WESSELS, Osnabruck (DE)

(73) Assignee: Amazonen-Werke H. Dreyer SE & Co. KG, Hasbergen-Gaste (DE)

(21) Appl. No.: 18/873,626

(22) PCT Filed: Jun. 15, 2023
(86) PCT No.: PCT/EP2023/066145

§ 371 Date: Dec. 10, 2024

(30) Foreign Application Priority Data
Jun. 17, 2022 (EP) 22179576.8

(51) Int. Cl. A01C 17/00

(52) U.S. Cl. CPC A01C 17/008; A01C 17/001

(57) ABSTRACT

A method for determining a machine- and spreading material-specific and lane-independent maximum working width, comprising throwing spreading material by means of at least one spreader disk of an agricultural spreader and detecting the thrown spreading material by means of a sensory spreading material detection system of the agricultural spreader.

### CROSS REFERENCE TO RELATED APPLICATIONS

The present application claims priority under 35 U.S.C. § 365 to PCT/EP2023/066145 filed on Jun. 15, 2023 and under 35 U.S.C. § 119(a) to European Application No. 22179576.8 filed on Jun. 17, 2022, both of which are incorporate by reference in their entireties.

### BACKGROUND

The disclosure relates to a procedure for determining a machine- and spreading material-specific and lane-independent maximum working width for a spreading operation and to a system for determining a machine- and spreading material-specific and lane-independent maximum working width for a spreading operation.

A lane system or lane-dependent system is generally understood to refer to a system for processing a field, wherein the field is driven over by an agricultural implement in typically parallel, predetermined tracks. These tracks are also referred to as lanes. Typically, these lanes are spaced at a predetermined distance from one another. For example, in row crops, the lanes may be predetermined based on the row spacing of the row crops. In contrast, the lanes of the agricultural implement in a lane-independent system are not predetermined.

From the prior art there is known the setting and sensor-based readjustment of setting parameters of an agricultural spreader to achieve a working width predetermined by a lane system. In this context, document US 2014/263713 A1 discloses a method for controlling a device for changing the spreading sector of a disk spreader.

In some cases, however, a maximum working width independent of the lane is to be set on the agricultural spreader, for example to minimize the number of parallel runs required. A method for determining a maximum working width independent of the lane is not yet known.

### SUMMARY

One object of the disclosure is therefore enabling the determination of a machine- and spreading material-specific and lane-independent maximum working width. In the following, the term “maximum working width” refers to both a maximum technically possible working width, hereinafter also referred to as “theoretical maximum working width”, and a maximum working width that the system may achieve at a substantially constant level, taking into account external influences, hereinafter also referred to as “variance-stable maximum working width”, unless otherwise stated. Accordingly, the term “variance-stable” in relation to a parameter of the system is to be understood to mean that the parameter may be kept essentially constant during operation, taking into account external influences, where “essentially constant” in this context means that a fluctuation of the parameter within a predetermined tolerance range may be allowed.

The problem can be solved by a method that includes the throwing of spreading material by means of at least one spreader disk of an agricultural spreader, and the detection of the thrown spreading material by means of a sensory spreading material detection system of the agricultural spreader, wherein, as part of the method according to the disclosure, the machine- and spreading material-specific and lane-independent maximum working width is calculated by an electronic data processing device, wherein the electronic data processing device upon calculating the machine- and spreading material-specific and lane-independent maximum working width takes into account measured values determined by the spreading material detection system and/or one or more spreading parameters derived therefrom.

Due to the comparatively precise sensor-based detection of the thrown spreading material and a control system based on it, the actual lateral distribution of the spreading material during the spreading process only slightly deviates from an intended target lateral distribution, which was determined prior to or during the spreading process. The spreading result for lane-independent spreading processes may thus be significantly improved.

The measured values determined by the spreading material detection system and/or the one or more spreading parameters derived therefrom may affect the distribution of the thrown spreading material and/or the ejection direction of the thrown spreading material. The spreading material detection system may be configured to determine the spreading material distribution in a near range of the at least one spreader disk. Alternatively or additionally, the spreading material collection system may be configured to determine the flight speed and/or the ejection range of the thrown spreading material in a far range of the spreader disk. In this context, the near range of the spreader disk is the area, in which the spreading material is located immediately after leaving the spreader disk. When the spreading material is in the close range of the spreader disk, typically an ejection trajectory has not yet formed. The flight trajectory of the spreading material is still almost straight in the close range and is not characterized by external influences, such as wind influences, air friction influences and gravity influences. In contrast, such external influences on the flight trajectory of the spreading material in the far range of the spreading disk may no longer be neglected. It is possible that the far range includes an area, in which the individual spreading fans of several spreading disks overlap.

The measured values determined by the spreading material detection system and/or the one or more spreading parameters derived therefrom may relate to the flight speed of the spreading material thrown and/or the ejection range of the spreading material thrown. The spreading material detection system may have one or more detection sensors for detecting the flight speed of the spreading material thrown. These detection sensors may be arranged, for example, on a spreading material storage container of the spreader. The detection sensors for detecting the flight speed may operate according to the Doppler principle. In particular, the detection sensors may be radar sensors. It is considered herein that the detection sensors are aligned so that their direction of measurement extends along a main ejection direction of the spreading material. In particular, the measuring direction of the detection sensors of the flight speed may be aligned such that the spreading material moves approximately parallel to the measuring direction of the detection sensors over part of its flight trajectory, in particular during the transition from the near range to the far range. The spreading material may be fertilizer, for example.

Furthermore, the electronic data processing device may be configured to calculate a theoretical maximum ejection distance and/or a theoretical maximum working width on the basis of the determined flight speed of the thrown spreading material and/or the determined ejection direction and/or the determined ejection range of the thrown spreading material. The electronic data processing device may be configured to take into account one or more operating parameters of the at least one spreader disk when calculating the theoretical maximum ejection range and/or the theoretical maximum working width. The one or more operating parameters may, for example, include a disk radius of the at least one spreader disk and/or a rotational speed of the at least one spreader disk.

In particular, a correlation between an ejection range of the spreading material and a specific rotational speed, in particular the maximum rotational speed, of the disk may be known and the data processing device may be configured to take this correlation into account when calculating the theoretical maximum ejection range and/or the theoretical maximum working width. The correlation may have been determined by previous measurements. Alternatively or additionally, the relationship may be described by a mathematical formula. Data associated with the relationship may be stored in a memory unit of the data processing device.

A working width, an ejection range and an ejection direction or an ejection angle of the spreading material may, under constant conditions, form a triplet of values, thereby allowing the calculation of one of the values with the electronic data processing device if the other values are known. For example, the ejection range may be given by a set speed, and an ejection direction may be given by a desired target pattern, as explained below. This may allow the determination of the working width for a specific speed and a specific ejection direction. The relationship between the working width, the ejection range and the ejection direction or the ejection angle of the spreading material may be determined by previous measurements. Alternatively or additionally, the relationship may be described by a mathematical formula. Data associated with the relationship may be stored in a memory unit of the data processing device.

The electronic data processing device may be configured to reduce the theoretical maximum ejection range and/or the theoretical maximum working width to a variance-stable maximum ejection range and/or a variance-stable maximum working width when calculating the machine- and spreading material-specific and lane-independent maximum working width, in order to take into account expected external influences on the distribution of the spreading material. By reducing to a variance-stable maximum ejection range and/or variance-stable maximum working width, it may be ensured that sufficient control capacity is available to the system to constantly maintain the variance-stable maximum ejection range and/or variance-stable maximum working width during operation. In this way, the available control capacity may be used, for example, to react to unforeseen environmental influences, such as changing wind conditions, in order to maintain the variance-stable maximum ejection range and/or variance-stable maximum working width.

The electronic data processing device may be configured to calculate setting parameters for the spreader, via which the variance-stable maximum ejection range and/or variance-stable maximum working width are implemented during the spreading of the material. The setting of the calculated setting parameters may be carried out automatically by the spreader. Alternatively, the setting parameters may be displayed to the machine operator, thereby enabling him/her to perform the settings manually. Alternatively, the electronic data processing device may be configured to also calculate setting parameters for the theoretical maximum ejection range and/or the theoretical maximum working width, for example if no special requirements are placed on the variance stability.

The electronic data processing device may be configured to take into account adherence to one or more minimum requirements regarding the lateral distribution of the spreading material when calculating the machine- and spreading material-specific and lane-independent maximum working width.

A minimum requirement may relate to the shape of the spreading pattern. For example, the machine- and spreading material-specific and lane-independent maximum working width may be calculated in such a way that the spreading pattern does not deviate from a nominal spreading pattern shape by more than a tolerance value. The target spreading pattern may, in particular, be a pattern that enables a homogeneous and/or needs-based overall distribution of the spreading material when the spreader makes successive passes, in particular parallel passes. In this context, it is possible that the selection of the target spreading pattern may result in intentional overlapping of spreading material at predetermined points. Alternatively or additionally, the selection of the target spreading pattern may result in no spreading material being applied at certain points. The target spreading pattern may be triangular, for example. The target spreading pattern may also be trapezoidal. Other geometric shapes are also possible.

A spreading pattern shape may be determined by an ejection direction or an ejection angle of the spreading material. For example, an ejection angle of about 20° to 25° may result in a triangular shape. In other words, it is possible that a desired spreading pattern shape or spreading pattern target shape may be set by choosing the ejection direction or the ejection angle.

A minimum requirement may relate to a coefficient of variation. In this context, a coefficient of variation refers to a value that indicates the deviation of an achieved spreading pattern from a target spreading pattern. For example, the machine- and spreading material-specific and lane-independent maximum working width may be calculated in such a way that the deviation described by the coefficient of variation does not exceed a limit value. For example, the maximum working width may be calculated such that the coefficient of variation corresponds to a deviation of less than 15%, preferably less than 10%, of the achieved spreading pattern from the target spreading pattern. Furthermore, the machine- and spreading material-specific and lane-independent maximum working width may be calculated such that the expected lateral distribution deviations of the spreading material during the spreading process are within a specified tolerance range. If it is determined that the spreading pattern shape deviates from a spreading pattern target shape during spreading beyond a tolerance level, that the deviation during spreading, as described by the coefficient of variation, exceeds a limit value and/or that the lateral distribution variation of the spreading material during the spreading process are outside the specified tolerance range, a re-evaluation and a recalculation of the machine- and spreading material-specific and lane-independent maximum working width may be carried out by means of the electronic data processing device.

Even if the minimum requirements are met, a regular or irregular recalculation of the machine- and spreading material-specific and lane-independent maximum working width may be carried out by the electronic data processing device. This means that the quality of the spreading process may be improved during the spreading process. The determined working width may be transmitted to the operator or to a steering system so that the vehicle may be driven accordingly, either manually or automatically. External influences, such as changing wind or terrain, speed fluctuations or fluctuations in the spreading material feed, may lead to a change in the lateral distribution of the spreading material and it is therefore possible to take these influences into account when calculating the machine- and spreading material-specific and lane-independent maximum working width.

It may be the case that the calculated lane-independent maximum working width does not match a lane distance between two neighboring lanes. The reason for this is that, depending in particular on a selected target spreading pattern, an overlap of the spreading material applied during successive passes is desired in order to achieve a homogeneous lateral distribution of the spreading material. In this case, the lane distance may be smaller than the calculated lane-independent maximum working width, for example 5% to 25% smaller.

Accordingly, the electronic data processing device may also be configured to determine a lane distance between a lane currently being driven on and the following lane. The determined lane distance may be transmitted to the operator or to a steering system, thereby enabling a corresponding driving manually or automatically. The electronic data processing device may be configured to take into account the data from the spreading material detection system and/or the target spreading pattern and/or the calculated lane-independent maximum working width when determining the lane distance. In particular, a corresponding determination of the lane distance may be carried out in the case of a regular or irregular recalculation of the lane-independent maximum working width as described above.

The agricultural implement may also include at least one sensor for detecting environmental influences, in particular at least one sensor for detecting a wind speed and/or a wind direction. The electronic data processing device may be configured to take into account the sensor data of the at least one sensor when calculating and/or adjusting the machine- and spreading material-specific and lane-independent maximum working width.

In particular, the electronic data processing device may be configured to take into account in combination the data from the at least one sensor for detecting environmental influences and the data from the spreading material detection system when calculating and/or adjusting the machine- and spreading material-specific and lane-independent maximum working width. For example, the data from the spreading material detection system may be used to detect a deviation of the spreading material distribution from a target spreading pattern, and the data processing device may use the sensor data from the at least one sensor to detect environmental influences to adjust one or more operating parameters of the spreader disk in order to compensate for these environmental influences.

The electronic data processing device may also be configured to check, before changing lanes, whether an adjustment of the lane-independent maximum working width should be made for the following pass, for example based on a target spreading pattern. The electronic data processing device may be configured to indicate to the driver of the spreader any necessary adjustment of the lane-independent maximum working width. The electronic data processing device may also be configured to make, in particular autonomously, any necessary adjustment to the lane-independent maximum working width.

As described above, in the event of such an adjustment to the lane-independent maximum working width a new lane distance may also be determined by the electronic data processing device. Furthermore, the throwing of spreading material and/or the detection of the thrown spreading material by means of the spreading material detection system may be carried out at one or more calibration speeds at the at least one spreader disk and/or upon using a calibration speed window at the at least one spreader disk. A calibration speed may, for example, be a maximum speed of the at least one spreader disk. A calibration speed may also be another predetermined speed of the at least one spreader disk. The calibration speed window may be an upper speed range of the at least one spreader disk.

The quantity and/or weight of the spreading material on the at least one spreader disk may be determined by sensors. When calculating the machine- and spreading material-specific and lane-independent maximum working width, the electronic data processing device may take into account the sensor-determined quantity and/or the sensor-determined weight of the spreading material on the at least one spreader disk. The quantity may be determined, for example, by measuring the torque on the spreader disk, in particular on at least one vane of the spreader disk or on the drive shaft of the spreader disk. Alternatively or additionally, the quantity may be determined by means of one or more weighing cells and/or by adjusting a metering slide, by means of which the amount of spreading material applied to the spreader disk and/or the point of impact of the spreading material applied to the spreader disk may be varied.

The data processing device may also be configured to determine and/or adjust a quantity of spreading material to be dispensed on the basis of a calculated machine- and spreading material-specific and lane-independent maximum working width.

Furthermore, the current configuration and/or one or more current operating parameters of the spreader may be determined. When calculating the machine- and spreading material-specific and lane-independent maximum working width, the electronic data processing device may take into account the determined current configuration or the determined current operating parameter(s) of the spreader. The electronic data processing device may be configured to preferably take into account a control reserve when calculating the machine- and spreading material-specific and lane-independent maximum working width. That is, the maximum working width may also be maintained in the event of a changing spreading situation. The configuration may relate to the type of disk used or the geometry of the spreader disk used. If the spreader disks have adjustable ejection vanes, the configuration may also affect the setting of the ejection vanes, in particular the ejection vane length and/or their angle of incidence. The operating parameters may affect the current disk speed and/or the current setting of a spreading material feed adjustment device. The point of impact of the spreading material on the spreader disk may be adjusted using the spreading material delivery adjustment device. The point of impact of the spreading material on the at least one spreader disk may be adjusted in the radial direction and/or in the circumferential direction using the spreading material delivery adjustment device. The operating parameters may also relate to the position of a metering slide valve, by means of which the amount of spreading material applied to the spreader disk and/or the point of impact of the spreading material applied to the spreader disk may be varied. The operating parameters may also relate to the conveying speed of a conveyor belt, such as a belt floor. Such a conveyor belt may be used, for example, in towed spreaders, in which the spreading material is conveyed from an elongated storage container to the spreader disks.

The electronic data processing device may be configured to calculate the machine- and spreading material-specific and lane-independent maximum working width on the basis of a notional spreading scenario, in which the spreading pattern is subject to statistical fluctuations. The electronic data processing device may be configured to initially assume an idealized spreading pattern and then to take into account statistically probable deviations from the idealized spreading pattern. For example, the electronic data processing device may be configured to simulate the spreading scenario on the basis of spreading specifications. The spreading specifications may, for example, relate to the expected driving speeds and/or the expected driving directions or the expected movement path. The spreading scenario may also take into account parameters influencing the spreading of the material, such as environmental or weather influences. The spreading preconditions may, for example, relate to the spreading material to be spread and/or its properties. The spreading preconditions may be defined by an operator. The spreading preconditions may be defined by a predetermined processing routine. For example, the predetermined processing routine may be based on a spreading map for the spreading material to be spread.

Furthermore, the electronic data processing device may be configured to calculate the machine- and spreading material-specific and lane-independent maximum working width based on a notional spreading scenario, in which the spreading pattern is subject to fluctuations due to one or more assumed external influences, in particular an assumed wind influence. For example, the influence of an assumed maximum wind force on the spreading pattern may be taken into account when calculating the machine- and spreading material-specific and lane-independent maximum working width. The maximum wind force may, for example, be specified and/or defined by the operator and/or derived as an expected value from average historical data.

The electronic data processing device may also be configured to take into account a spreading pattern tolerance mode and/or a tolerated spreading pattern fluctuation, set in particular by the operator, when calculating the machine- and spreading material-specific and lane-independent maximum working width. Several spreading pattern tolerance modes may be set. For example, a spreading pattern tolerance mode may allow strong spreading pattern fluctuations so it may be focused on achieving a maximum working width. For example, a spreading pattern tolerance mode may only allow small spreading pattern fluctuations so that the focus may be on reliably adhering to the spreading pattern. A spreading pattern tolerance mode may, for example, allow spreading pattern deviations that represent a compromise between achieving the maximum working width and reliably adhering to the spreading pattern. The tolerated spreading pattern deviation may also be directly specified, for example by the manufacturer and/or the operator. In particular, the electronic data processing device may be configured to also record and document spreading errors and deviations from an expected spreading pattern, so that these errors and deviations may be taken into account in a future spreading process.

The control device may be configured to automatically adjust the setting parameters on the spreader so as to obtain the calculated machine- and spreading material-specific maximum working width. The setting parameters may, for example, relate to a disk speed of a spreader disk, a vane length of a spreader disk, a vane position of a spreader disk, a point of impact of the spreading material on a spreader disk, an inclination and/or a metered quantity of the spreading material. The inclination may be an inclination of the spreader and/or an inclination of the spreading mechanism and/or an inclination of a spreader disk and/or an inclination of a spreading vane.

The electronic data processing device may include one or more storage devices. The electronic data processing device may include one or more processors. The electronic data processing device may, for example, be configured as an on-board computer for a spreader. Alternatively or additionally, the electronic data processing device may be configured as a tablet computer.

The underlying problem of the disclosure can also be solved by a system of the type mentioned at the beginning, whereby the system according to the disclosure has an electronic data processing device configured to calculate the machine- and spreading material-specific and lane-independent maximum working width and to take into account measured values determined by the spreading material detection system and/or one or more spreading parameters derived therefrom when calculating the machine- and spreading material-specific and lane-independent maximum working. The system according to the disclosure is preferably configured to determine the machine- and spreading material-specific and lane-independent maximum working width by means of a method according to one of the embodiments described above. With regard to the advantages and modifications of the system according to the disclosure, reference is thus made to the advantages and modifications of the method according to the disclosure.

### BRIEF DESCRIPTION OF THE DRAWINGS

In the following, preferred embodiments of the disclosure are explained and described in more detail with reference to the accompanying drawings. In the drawings:

FIG. 1 shows a method known from the prior art for determining a lane distance in a schematic representation;

FIG. 2 shows a system for determining a machine- and spreading material-specific and lane-independent maximum working width in a schematic representation;

FIG. 3 shows a schematic representation of the working width fluctuations occurring at maximum disk speed;

FIG. 4 shows a schematic representation of the working width fluctuations occurring at a variance-stable disk speed;

FIG. 5 shows a schematic representation of the quantity fluctuations occurring at maximum disk speed in the transverse distribution;

FIG. 6 shows a schematic representation of the quantity fluctuations occurring at the variance-stable disk speed in the transverse distribution;

FIG. 7 shows a schematic representation of a correlation between a maximum working width and a lane distance; and

FIG. 8 shows a schematic representation of a method for determining a machine- and spreading material-specific and lane-independent maximum working width.

### DETAILED DESCRIPTION

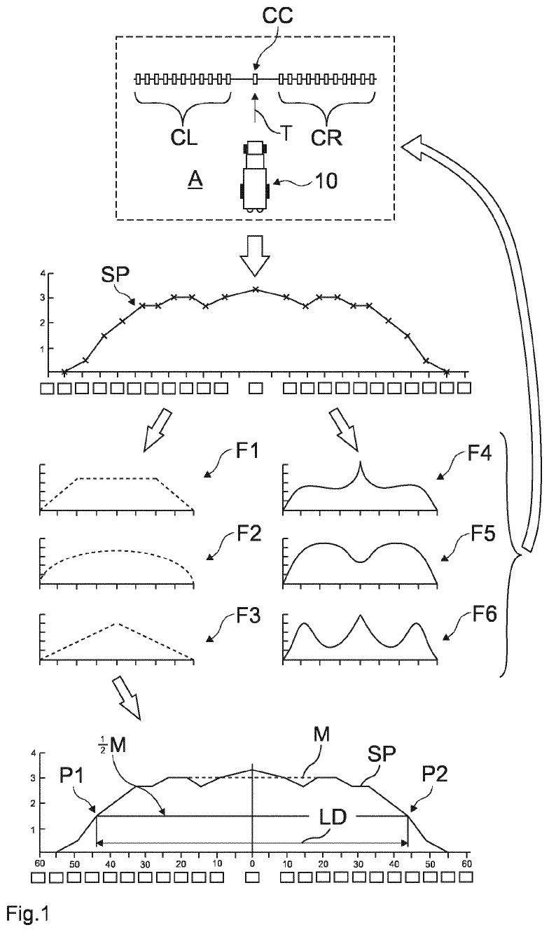

FIG. 1 shows a method known from the prior art for determining a lane distance LD for the material-independent spreading of spreading material.

First, as part of a spreading test on an agricultural area A, collecting containers CL, CC, CR are positioned so as to collect the spreading material by the collecting containers CL, CC, CR upon driving over the collecting containers CL, CC, CR. While driving over the collecting containers CL, CC, CR the spreader 10 moves in the direction of travel T.

Subsequently, the quantities of spreading material collected by the collecting containers CL, CC, CR are entered into a data sheet so that a rough spreading pattern SP may be determined by means of the container collection quantities.

The shape of the graphically determined spreading pattern SP is then compared with spreading pattern F1-F6. If the graphically determined spreading pattern SP has a trapezoidal shape F1, a semi-oval F2 or a triangular shape F3, the setting parameters used for the spreading test are evaluated as suitable without further optimization, so that these setting parameters are retained for further spreading of spreading material.

If the spreading patterns are unsuitable (F4-F6), the operator must adjust one or more setting parameters, depending on the spreading pattern, and repeat the spreading test. This process has to be repeated until an acceptable spreading pattern (F1-F3) is determined.

A spreading pattern-specific lane distance LD is then derived from the graphically determined spreading pattern SP. To do this, the average material quantity M in a central area of the spreading pattern SP is entered in a graph. Subsequently, half of the material quantity M is determined and the points of intersection P1, P2 are marked on the spreading pattern. The distance between points P1, P2 corresponds to the lane distance LD to be maintained by the machine operator.

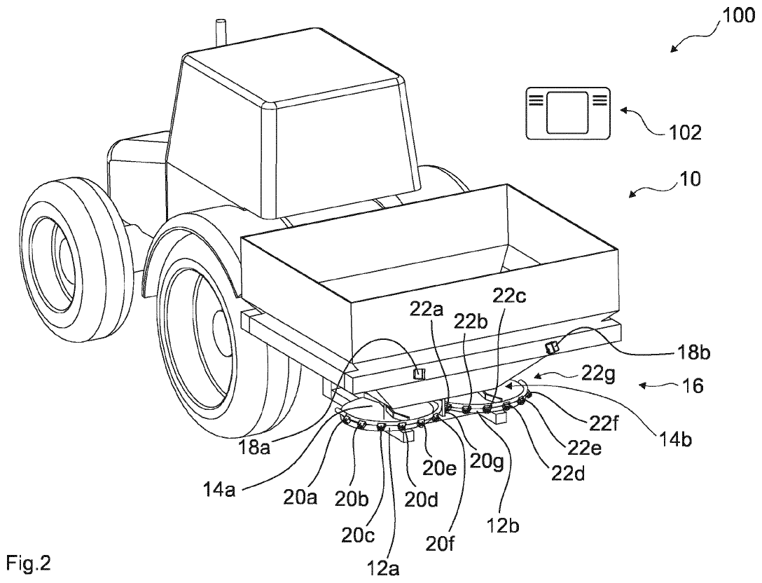

FIG. 2 shows a system 100 for determining a machine- and spreading material-specific and lane-independent maximum working width WWₘₐₓ, WW_{max,VS}. In this case, WW_{max,VS} denotes a maximum working width that is stable in terms of variance. The system 100 includes a sensory spreading material detection system 16 of a spreader 10. The spreading material detection system 16 is configured to detect the spreading material thrown off the spreader disks 12a, 12b of the spreader 10.

The system 100 further includes an electronic data processing device 102 that is configured to calculate the machine- and spreading material-specific and lane-independent maximum working width WWₘₐₓ, WW_{max,VS} and, when calculating the machine- and spreading material-specific and lane-independent maximum working width WWₘₐₓ, WW_{max,VS}, the electronic data processing device 102 may take into account measured values determined by the spreading material detection system 16 and/or one or more spreading parameters derived therefrom. The electronic data processing device 102 may, for example, be the on-board computer of the spreader 10.

The spreading material detection system 16 includes detection sensors 18a, 18b. The detection sensor 18a is assigned to the spreader disk 12a and is configured to detect the flight speed of the spreading material ejected by the spreader disk 12a. The detection sensor 18b is assigned to the spreader disk 12b and is configured to detect the flight speed of the spreading material ejected by the spreader disk 12b. The detection sensors 18a, 18b may, for example, be provided as radar sensors.

The spreading material detection system 16 also includes detection sensors 20a-20g, 22a-22h. The detection sensors 20a-20g are assigned to the spreader disk 12a and are configured to detect the ejection direction of the spreading material ejected by the spreader disk 12a. The detection sensors 22a-22g are assigned to the spreader disk 12b and are configured to detect the ejection direction of the spreading material ejected by the spreader disk 12b. The detection sensors 20a-20g and 22a-22h may, for example, be provided as radar sensors.

The electronic data processing device 102 determines a theoretical maximum ejection range and/or a theoretical maximum working width WWₘₐₓ on the basis of the sensed speeds of the spreading material and/or the determined ejection directions of the ejected spreading material. When calculating the machine- and spreading material-specific and lane-independent maximum working width, the electronic data processing device 102 reduces the theoretical maximum working width WWₘₐₓ to a variance-stable working width WW_{max,VS}, to take into account expected external influences on the spreading material distribution.

The electronic data processing device 102 then causes the operating parameters on the spreader 10 to be adjusted so as to obtain the variance-stable working width WW_{max,VS}. In the process, a suitable disk speed is set for the spreader disks 12a, 12b and a suitable point of impact of the material to be spread is set with respect to the spreader disks 12a, 12b. The point of interaction of the spreading material with respect to the spreader disks 12a, 12b is set by means of spreading material feed adjustment devices 14a, 14b of the spreader 10.

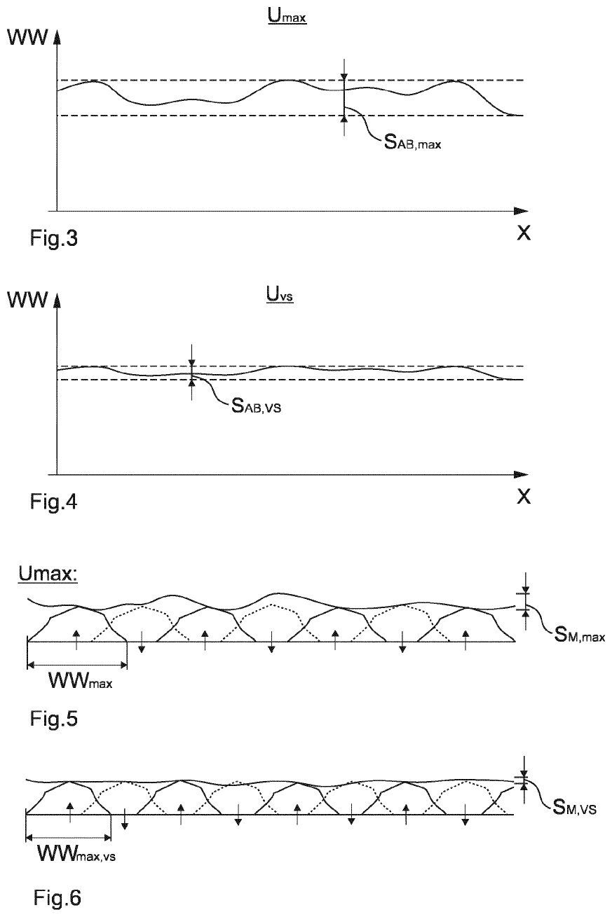

FIG. 3 shows that pronounced working width fluctuations S_{AB,max} may occur at maximum disk speed Uₘₐₓ during the spreading of the material, since it may be the case that external influences may no longer be compensated for, or may be compensated for only insufficiently, by the control system. When calculating the machine- and spreading material-specific and lane-independent maximum working width WW_{max,VS}, the electronic data processing device 102 takes into account adherence to minimum requirements for the lateral distribution of the spreading material. The machine- and spreading material-specific and lane-independent maximum working width WW_{max,VS} is calculated by the data processing device 102 such that the working width fluctuation S_{AB,VS} are within a tolerance range. FIG. 4 shows that, for a lower variance-stable disk speed U_{VS}, the determined machine- and spreading material-specific and lane-independent maximum working width WW_{max,VS} is below the theoretical maximum working width WWₘₐₓ. However, a certain variance stability is maintained so that the working width fluctuations S_{AB,VS} are within a tolerance range.

FIGS. 5 and 6 show that the quantity fluctuations during the lateral distribution of the spreading material when performing parallel passes at the variance-stable working width WW_{max,VS} are considerably less than the quantity fluctuations when performing parallel passes at the maximum working width WWₘₐₓ. The quantity fluctuations S_{M,VS} when performing parallel passes with the variance-stable working width WW_{max,VS} are within a tolerance range, in contrast to the fluctuations S_{M,max} when performing parallel passes with the maximum working width WWₘₐₓ. FIGS. 5 and 6 also show that a certain overlap of the spreading material spread in successive passes, especially in the opposite direction, is necessary to achieve a homogeneous lateral distribution of the spreading material.

Furthermore, it is evident that the lane distance LD is less than the maximum working width WWₘₐₓ or the variance-stable working width WW_{max,VS}.

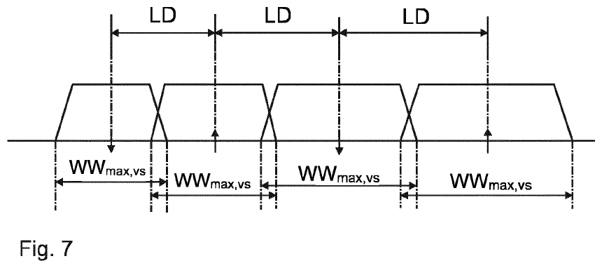

FIG. 7 shows how a changing variance-stable working width WW_{max,VS}, for example due to environmental influences, affects a lane distance LD. It is evident that, in order to reduce quantity fluctuations in the lateral distribution of the spreading material, an adjustment of the variance-stable working width WW_{max,VS} is accompanied by a corresponding adjustment of the lane distance LD. Both the variance-stable working width WW_{max,VS} and the lane distance LD are symmetrical to the position of the agricultural spreader. Thus, based on the variance-stable working width WW_{max,VS}, the lane distance LD may be determined based on the overlap necessary for uniform spreading of the spreading material.

The new lane distance LD and/or the newly determined variance-stable working width WW_{max,VS} may be communicated to the driver, for example before changing lanes. It is also possible that the driver is given instructions based on the new lane distance on how to drive the next lane. Furthermore, it is possible that the agricultural spreader autonomously approaches and drives off the next lane based on the new lane distance.

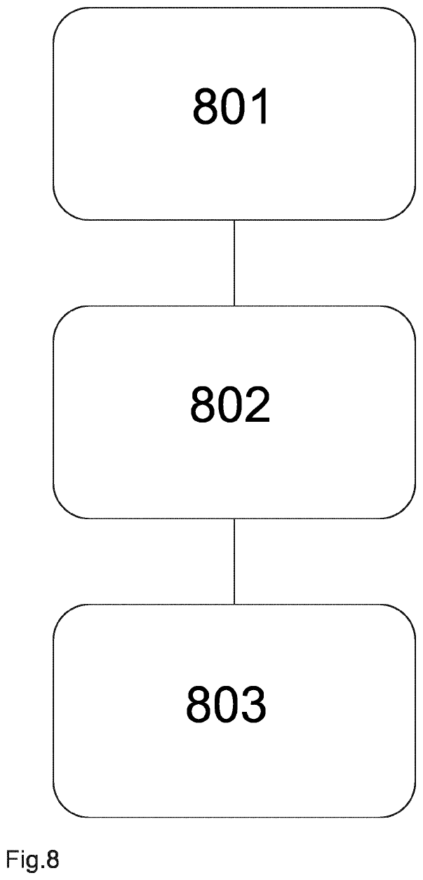

FIG. 8 shows a schematic representation of a method for determining a machine- and spreading material-specific and lane-independent maximum working width. In step 801, spreading material is thrown off by means of at least one spreader disk of an agricultural spreader. In step 802, the thrown spreading material is detected by means of a sensory spreading material detection system of the agricultural spreader. In step 803, the machine- and spreading material-specific and lane-independent maximum working width is calculated by means of an electronic data processing device, wherein the electronic data processing device takes into account measured values determined by the spreading material detection system and/or one or more spreading parameters derived therefrom when calculating the machine- and spreading material-specific and lane-independent maximum working width.

The agricultural spreader may, for example, be the spreader 10 shown in FIG. 2.

### REFERENCE SIGNS

10 Spreader
12a, 12b Spreader disks
14a, 14b Spreading material feed adjusting device
16 Spreading material detection system
18a, 18b Detection sensors
20a-20g Detection sensors
22a-22g Detection sensors
100 System
102 Data processing device
WW Working width
WWₘₐₓ Maximum working width
WW_{max,VS} Variance-stable maximum working width
CL Collection container
CR Collection container
CC Collection container
T Direction of travel
F1-F6 Spreading patterns
LD Lane distance
A usable area
SP Spreading pattern
S_{AB,max} Working width fluctuation at maximum speed
S_{AB,VS} Working width fluctuation at variance-stable speed
S_{M.max} Quantity fluctuations at maximum speed
SM,VS Quantity fluctuations at variance-stable speed
P1, P2 Points
U disk (rotary) speed
UVS Variance-stable disk speed
Umax Maximum speed

1. A method for determining a machine- and spreading material-specific and lane-independent maximum working width for a spreading operation, comprising:
throwing spreading material by means of at least one spreader disk of an agricultural spreader;
detecting the thrown spreading material by means of a sensory spreading material detection system of the agricultural spreader; and
calculating the machine- and spreading material-specific and lane-independent maximum working width using an electronic data processing device, the electronic data processing device taking into account, when calculating the machine- and spreading material-specific and lane-independent maximum working width, measured values determined by the spreading material detection system and/or one or more spreading parameters derived therefrom.

2. The method according to claim 1, wherein the measured values determined by the spreading material detection system or the one or more spreading parameters derived therefrom relate to the distribution of the thrown spreading material or the ejection direction of the thrown spreading material.

3. The method according to claim 1, wherein the measured values determined by the spreading material detection system or the one or more spreading parameters derived therefrom relate to the flight speed of the thrown spreading material or the ejection range of the thrown spreading material.

4. The method according to claim 2, wherein the electronic data processing device calculates a theoretical maximum ejection range or a theoretical maximum working width on the basis of the determined flight speed of the thrown spreading material or the determined ejection direction of the thrown spreading material, wherein the electronic data processing device, when calculating the machine- and spreading material-specific and lane-independent maximum working width, reduces the theoretical maximum ejection range or the theoretical maximum working width to a variance-stable maximum ejection range or a variance-stable maximum working width in order to take into account expected external influences on the distribution of the spreading material.

5. The method according to claim 1, wherein the electronic data processing device, when calculating the machine- and spreading material-specific and lane-independent maximum working width, takes into account adherence to one or more minimum requirements relating to the lateral distribution of the spreading material.

6. The method according to claim 1, wherein the throwing of the spreading material or the detecting of thrown spreading material using the spreading material detection system are performed at one or more calibration speeds at the at least one spreader disk or when using a calibration speed window at the at least one spreader disk.

7. The method according to claim 1, further comprising:
determining, in a sensor-based manner, the quantity or the weight of the spreading material located on the at least one spreader disk;
wherein the electronic data processing device takes into account the quantity determined in a sensor-based manner or the weight determined in a sensor-based manner of the spreading material located on the at least one spreader disk when calculating the machine- and spreading material-specific and lane-independent maximum working width.

8. The method according to claim 1, further comprising:
determining the current configuration or one or more current operating parameters of the agricultural spreader;
wherein the electronic data processing device takes into account the determined current configuration or the determined current operating parameter or parameters of the spreader when calculating the machine- and spreading material-specific and lane-independent maximum working width.

9. The method according to claim 1, wherein the electronic data processing device, when calculating the machine- and spreading material-specific and lane-independent maximum working width, uses as a basis a notional spreading scenario, in which the spreading pattern is subject to statistical fluctuations.

10. The method according to claim 1, wherein the electronic data processing device, when calculating the machine- and spreading material-specific and lane-independent maximum working width, uses as a basis a notional spreading scenario, in which the spreading pattern is subject to fluctuations due to one or more assumed external influences, in particular an assumed wind influence.

11. The method according to claim 1, wherein the electronic data processing device, when calculating the machine- and spreading material-specific and lane-independent maximum working width, takes into account a spreading pattern tolerance mode set, by the operator or a tolerated spreading pattern fluctuation set, by the operator.

12. The method according to claim 1, wherein a control device causes an automatic adjustment of setting parameters so as to obtain the calculated machine- and spreading material-specific and lane-independent maximum working width at the spreader.

13. A system for determining a machine- and spreading material-specific and lane-independent maximum working width for a spreading operation, comprising:
a sensory spreading material detection system of a spreader, wherein the spreading material detection system is configured to detect spreading material thrown off from at least one spreader disk of the spreader; and
an electronic data processing device configured to calculate the machine- and spreading material-specific and lane-independent maximum working width and to take into account measured values determined by the sensory spreading material detection system or one or more spreading parameters derived therefrom when calculating the machine- and spreading material-specific and lane-independent maximum working width.
